(19) United States
(12) Patent Application Publication
(10) Pub. No.: US 2014/0210703 A1
(43) Pub. Date: Jul. 31, 2014

(54) METHOD OF UNLOCKING AND SUBSEQUENT APPLICATION LAUNCH IN PORTABLE ELECTRONIC DEVICE VIA ORIENTATION SENSING

(71) Applicant: SAMSUNG ELECTRONICS CO., LTD., Suwon-si (KR)

(72) Inventors: Venkataramana NARASIMHAN, Plano, TX (US); Alexander CHU, Dallas, TX (US)

(73) Assignee: SAMSUNG ELECTRONICS CO. LTD., Suwon-si (KR)

(21) Appl. No.: 13/755,939

(22) Filed: Jan. 31, 2013

(51) Int. Cl. G06F 21/36

(52) U.S. Cl. CPC G06F 21/36
USPC 345/156

(57) ABSTRACT

An apparatus and method for unlocking in a portable electronic device via orientation sensing are provided. The device includes a display screen and at least one orientation sensor. The method includes displaying at least one moveable object on the display screen, sensing a change in an orientation of the device, moving the moveable object in accordance with the sensed change in orientation, and unlocking the device if the moveable object moves in accordance with a predetermined movement.

### BACKGROUND OF THE INVENTION

1. Field of the Invention

The present invention relates to an apparatus and method for unlocking and subsequent application launch in a portable electronic device. More particularly, the present invention relates to an apparatus and method for unlocking and subsequent application launch via orientation sensing.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

A mobile terminal will typically be in either an active use state or a dormant state. When in the dormant state, the mobile terminal can receive incoming signals, but will not receive normal inputs through a user interface. Further, the mobile terminal in the dormant state will not display visual output. This achieves significant power savings because the majority of the time the mobile terminal is not in active use, and therefore the majority of the time it is unnecessary to illuminate a display.

In contrast, when the mobile terminal is in the active use state, it will accept normal user inputs through a keypad, a touchscreen, buttons, voice commands, etc. Further, the mobile terminal in the active use state will typically have audio and/or visual output for general operation and for any applications in active use. The visual output typically entails illuminating a display screen, which is responsible for significant power consumption.

Therefore, a mobile terminal in the dormant state will have the various user inputs disabled so as to not inadvertently or unintentionally launch applications, illuminate the display, “pocket dial” phone numbers and use up limited service plan minutes, etc.

To transition from the dormant state to the active use state, a mobile terminal may employ a two step procedure. In a first step, a user will enter a specific input such as pushing a power button to signal the mobile terminal that he wishes the terminal to transition to the active use state. The mobile terminal will then enable user input and the display temporarily. In order to ensure that the mobile terminal does not transition to the active use state accidentally, a second confirmation step of entering a specific input is necessary. If the confirmation step is not completed within a predetermined amount of time, then the first step is presumed to have been invoked accidentally and the mobile terminal returns to the dormant state wherein the user inputs are disabled and the display screen is not illuminated.

More recently, mobile terminals have been provided with orientation sensors. For example, the mobile terminal may include one or more accelerometers, magnetic field sensors, etc., to determine an orientation of the mobile terminal and any change in the determined orientation.

A related art method of unlocking a mobile terminal by using a predetermined rotation is known. However, there has not previously been known a method using other orientation inputs. In particular, the rotation method of the related art is difficult to perform using one hand alone.

Further, there has not previously been known a method wherein a display screen displays an interactive interface for the orientation motions required to unlock the mobile terminal.

Accordingly, there is a need for an apparatus and method for providing an improved unlocking method in a mobile terminal that can be performed easily by a user holding the mobile terminal in one hand.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for unlocking and subsequent application launch in a portable electronic device via orientation sensing.

In accordance with an aspect of the present invention, a method for unlocking in a portable electronic device via orientation sensing is provided. The device includes a display screen and at least one orientation sensor. The method includes displaying at least one moveable object on the display screen, sensing a change in an orientation of the device, moving the moveable object in accordance with the sensed change in orientation, and unlocking the device if the moveable object moves in accordance with a predetermined movement.

In accordance with another aspect of the present invention, a portable electronic device is provided. The device includes a display screen for displaying at least one moveable object, at least one orientation sensor for sensing a change in an orientation of the device, and a controller for controlling the displayed moveable object to move according to the change in the orientation of the device, for determining whether the moveable object moves in accordance with a predetermined movement, and for unlocking the device if the moveable object moves in accordance with the predetermined movement.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a mobile terminal according to the related art;

FIGS. 2a-2d are orientations of a mobile terminal and corresponding screen displays according to an exemplary embodiment of the present invention;

FIGS. 3a-3f illustrate orientations of a mobile terminal and corresponding screen displays according to an exemplary embodiment of the present invention;

FIG. 4 shows a screen display according to an exemplary embodiment of the present invention;

FIG. 5 shows an initial screen display according to an exemplary embodiment of the present invention;

FIG. 6 is a flowchart of an unlocking process according to an exemplary embodiment of the present invention; and

FIG. 7 is a block diagram of a portable device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for unlocking and subsequent application launch in a portable electronic device via orientation sensing.

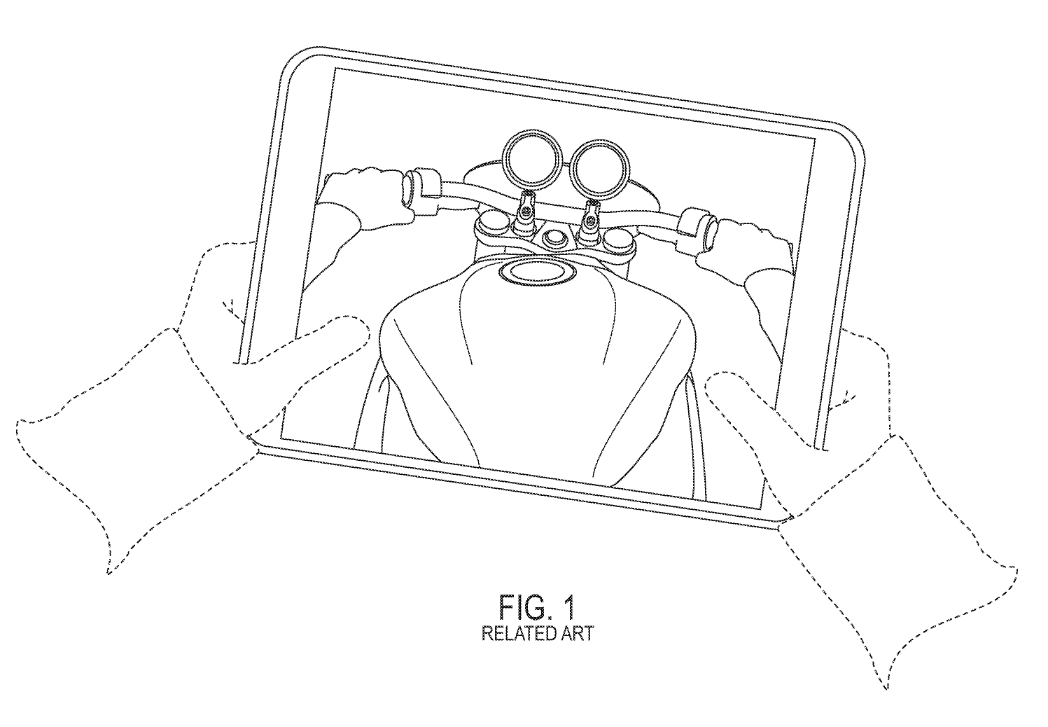

FIG. 1 is a mobile terminal according to the related art.

Referring to FIG. 1, the mobile terminal is shown where a user is playing a game, wherein user inputs are according to the orientation of the mobile terminal. The game in this is example is a racing game wherein the racing vehicle is controlled by an orientation of the mobile terminal The mobile terminal is equipped with orientation sensors that detect an orientation or change in orientation of the mobile terminal as user inputs. For example, a user may indicate a direction and degree of turning, acceleration, deceleration, etc., according to an orientation of the mobile terminal That is, for example, a user may input that the racing vehicle should turn, for example, to the right, by tilting the mobile terminal, for example, to the right. The degree of the turn may be according to the degree of the corresponding tilt.

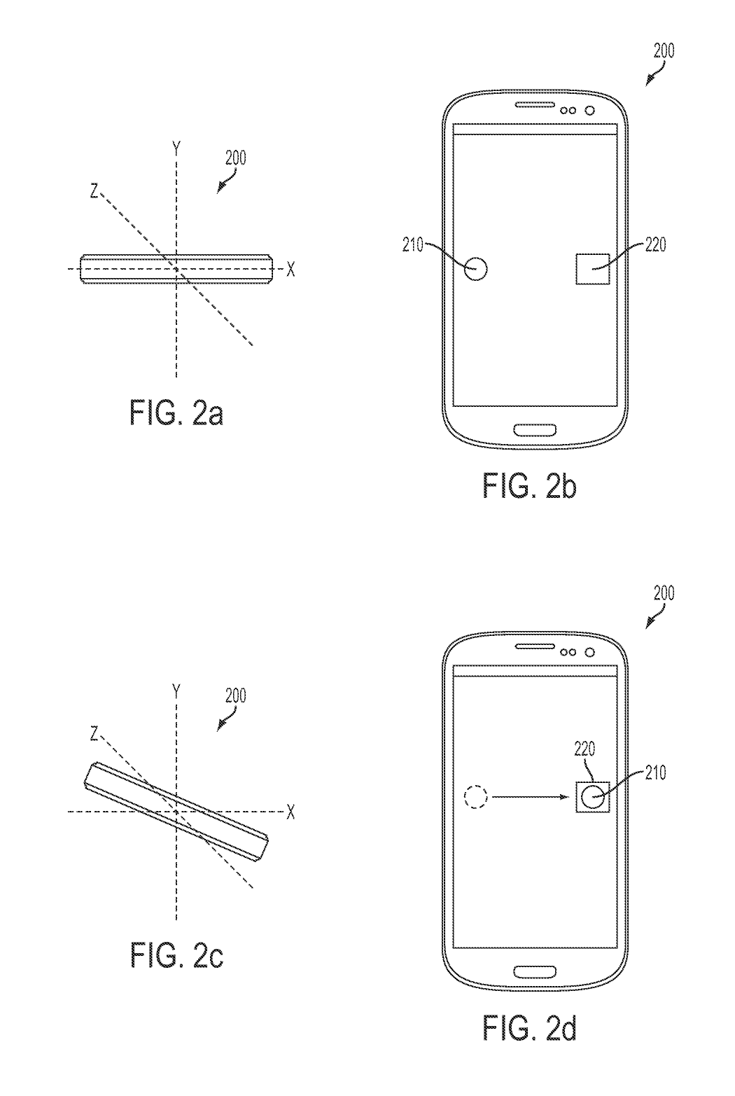

FIGS. 2a-2d are orientations of a mobile terminal and corresponding screen displays according to an exemplary embodiment of the present invention.

Referring to FIG. 2a, a device 200 will initially be held in an unpredictable orientation by a user when the user desires to unlock the device. When the user indicates a wish to unlock the device 200, such as by pressing a power button with a finger or thumb of the hand holding the device 200, the device 200 will make an initial determination of its orientation. Any three dimensional orientation sensors may be used, such as accelerometers, magnetic field sensors, etc. Similarly, any three dimensional coordinate system may be used, such as Cartesian coordinates, polar coordinates, etc. The example in FIGS. 2a-2b uses Cartesian coordinates, but the present invention is not limited thereto.

In FIG. 2a, the device 200 is initially held in an approximately flat orientation. That is, a vertical axis Y with respect to the Earth is approximately orthogonal to front and back surfaces of the device 200. In FIG. 2b, which corresponds to FIG. 2a, a screen display is shown including at least one moveable object 210 and at least one immoveable object 220. The relative positions of the moveable object 210 and the immoveable object 220 are determined according to the orientation of the device 200. That is, the moveable object 210 and the immovable object 220 are positioned such that a detected tilt of the initial orientation of the device 200 would cause the moveable object 210, if it were an actual object subject to gravity, to move or fall in a direction away from the immovable object 220.

For example, in FIG. 2a, assume the device 200 initially includes a slight tilt to the left, that is, the left side of the device 200 is determined to be lower than the right side of the device 200. In this case, the moveable object 210 in FIG. 2b will be initially positioned to the left of the display, as if it had moved there under the influence of gravity, and the immoveable object 220 will be positioned on the right of the display.

In this example, the user will be able to see that the device 200 must be tilted to the right in order to move the moveable object 210 to the position of the immoveable object 220. If the user then tilts the device 200 such that the moveable object 210 moves as if due to gravity to the position of the immoveable object 220, as illustrated in FIGS. 2c-2d, when the moveable object 210 moves to the immoveable object 220 the mobile device 200 will interpret this input as the second step of the unlocking process and will then unlock the device 200.

By initially positioning the moveable object 210 in a lower position on the screen with respect to gravity than the immoveable object 220, a possibility of accidentally tilting the device 200 in a direction such that the moveable object 210 randomly moves to the immoveable object 220 is suppressed.

Although the moveable object 210 and the immovable object 220 have been exemplarily depicted with simple geometric shapes, the present invention is not limited thereto. To assist the user in intuitively understanding the required change of orientation required to unlock the device 200, the moveable object 210 and the immovable object 220 may depict objects that the user will recognize go together. For example, the moveable object 210 may be depicted as a bird and the immoveable object 220 may be depicted as a bird's nest, or the moveable object 210 may be depicted as a soccer ball and the immoveable object 220 may be depicted as a goal, etc.

According to another exemplary embodiment, the moveable object 210 may be a stream or flow from an initial point such as near the center of the display screen. For example, a watering can may be depicted with water flowing out, and a potted plant may be depicted as the immoveable object 220 such that the user will direct the flow of water to the plant. Similarly, the moveable object 210 may be depicted as a partially moving or flexible item such as an electric cord to a lamp, and the end of the cord may have a plug that the user must move to an electric socket as the immoveable object 220. Other implementations are of course possible. In all cases it is preferred that the moveable and immovable objects selected by the user be readily discernible and understandable what object or part of an object moves, and what object it most move to so as to unlock the device 200.

According to an exemplary embodiment of the present invention, predetermined pairs of moveable objects 210 and immoveable objects 220 may be included in the unlocking application. Alternatively, a user may select any visual image he chooses for either the moveable object 210 or the immovable object 220. For example, a user may use an image of himself for the moveable object 210 and an image of his spouse for the immovable object 220. It is recommended that the user select visual images such that he can readily determine which is moveable and which is immoveable.

Note that the movement according to gravity may alternatively be negative. For example, the moveable object 210 may be located and moved in a manner comparable to a balloon filled with helium or a bubble in a leveling device, such that the moveable object 210 initially is located in a highest position rather than a lowest position. In such an implementation, the positions of the immoveable object 210 and the immoveable object 220 would be reversed from the above description.

In an exemplary embodiment of the present invention, multiple moveable objects and immoveable objects may be used.

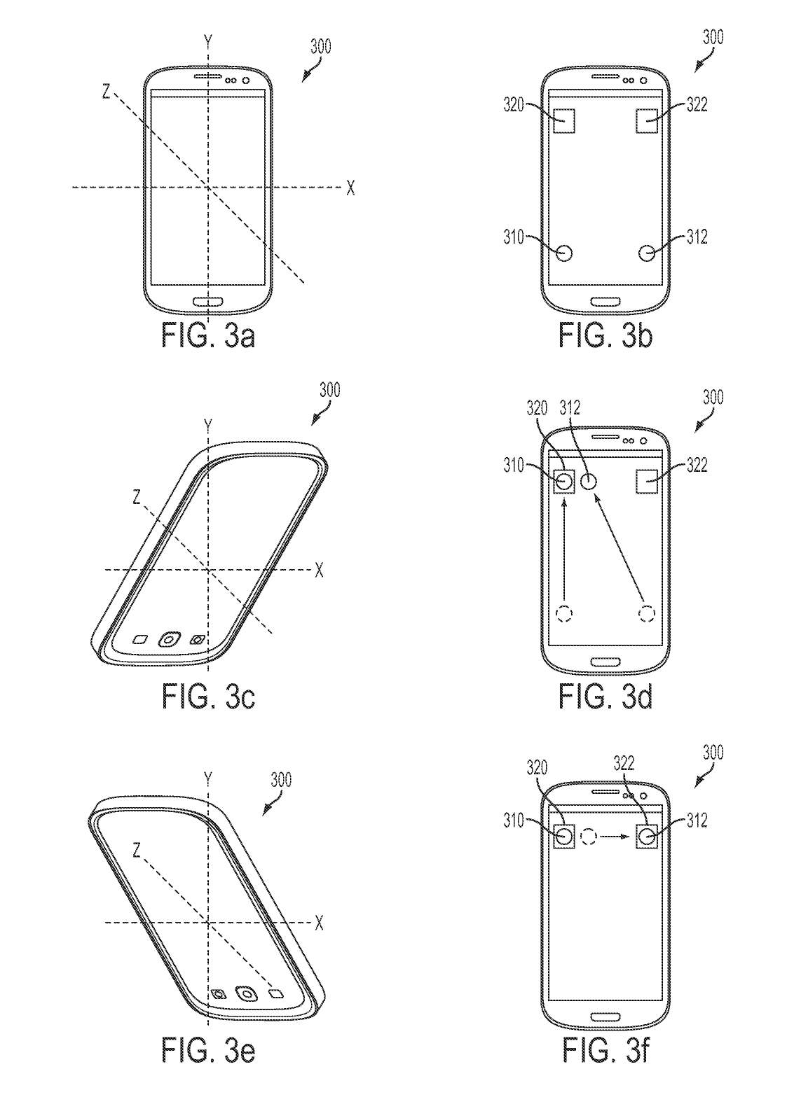

FIGS. 3a-3f illustrate orientations of a mobile terminal and corresponding screen displays according to an exemplary embodiment of the present invention.

Referring to FIGS. 3a-3b, an initial orientation and corresponding display screen are shown. In FIG. 3a a device 300 according to an exemplary embodiment of the present invention is shown in an initial upright position. In FIG. 3b multiple moveable objects 310 and 312 are shown in initial positions according to where they would move if subject to gravity, i.e., at the bottom of the display screen if the device 300 is held upright. Also in FIG. 3b, multiple immoveable objects 320 and 322 are shown in positions where the moveable objects 310 and 312 would not naturally move towards them if subject to gravity, i.e., at the top of the display screen if the device 300 is held upright.

The moveable objects 310 and 312 and the immoveable objects 320 and 322 may be positioned such that multiple movements of the device 300 are required to move the moveable object 310 and 312 to the immoveable objects 320 and 322. For example, they may be arranged such that the device must be tilted top downwards and towards the left, as shown in FIG. 3c, to move the moveable objects 310 and 312 such that one moveable object 310 moves to immoveable object 320, as shown in FIG. 3d. The moveable object 310 may then remain in immoveable object 320 unless the device 300 is tilted more than a predetermined threshold amount away from that location. The device 300 must also be tilted top downwards and towards the right, as shown in FIG. 3e, to move another moveable object 312 to the other immoveable object 322, as shown in FIG. 3f. It is preferred that the moveable objects 310 and 312 cannot be in a same location concurrently, so that, for example, only one of 310 and 312 may be in a location of a particular immoveable object, such as 320, at any time.

In the above exemplary embodiment, the device 300 may be configured such that a predetermined one of moveable objects 310 and 312 must be moved to each of immoveable objects 320 and 322. Alternatively, the device 300 may be configured such that either of moveable objects 310 and 312 may be moved to either one of immoveable objects 320 and 322, and the other to the other, to unlock the device 300.

If multiple moveable objects 310 and 312 objects are used, it is preferred that a color change or other visual indication be displayed when each moveable object has reached an immoveable object, so that the user can readily discern which moveable objects still must be moved to unlock the device 300.

Any combination of moveable and immoveable objects may be used. For example, if a stream of water from a watering can is used as the moveable object, there may be multiple plants to water at different points on the display as the immoveable objects. Similarly, if lamps with electric cords are used as multiple moveable objects, a single multi-socket electric outlet may be used as the immoveable object such that each electric plug must be moved to the electric outlet.

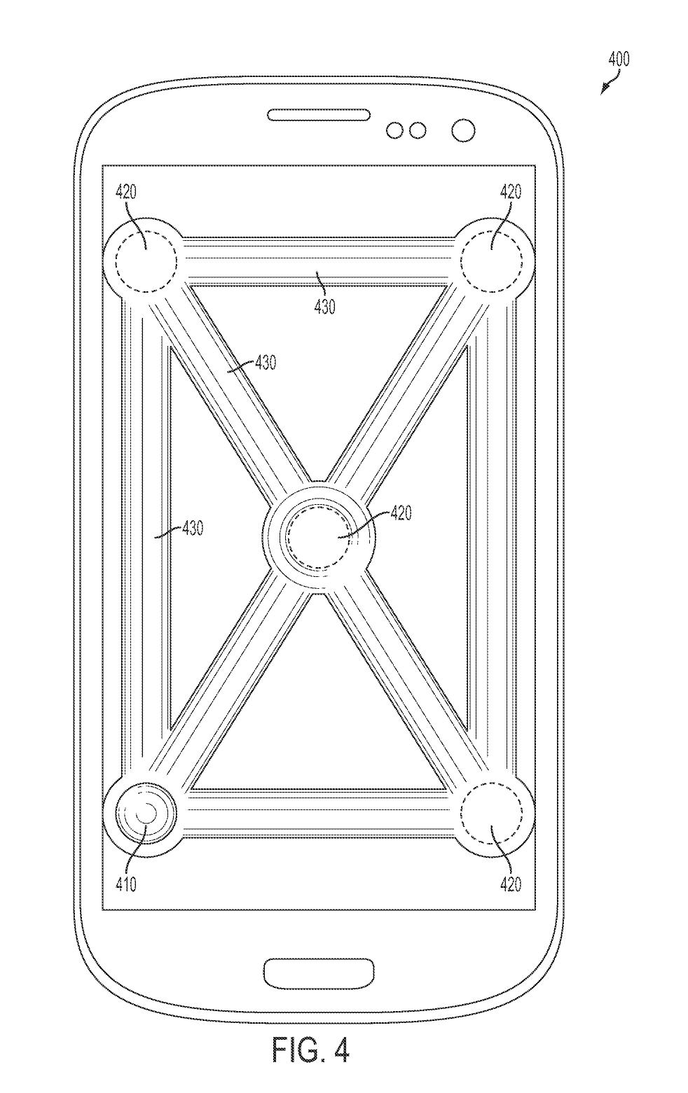

FIG. 4 shows a screen display according to an exemplary embodiment of the present invention.

Referring to FIG. 4, a moveable object 410 is shown with multiple immoveable objects 420. The immoveable objects 420 represent possible inputs to an unlocking code, thereby providing a level of password security. In this exemplary embodiment, the user may predetermine any sequence of any length of the immoveable objects 420 as the password input. The user may determine an easily remembered pattern among the immoveable objects 420 as a password sequence.

In an exemplary embodiment of the present invention, troughs or gutters 430 may be depicted between the different immoveable objects 420, such that the user can quickly and easily guide the moveable object 410 directly from one immoveable object 420 to another.

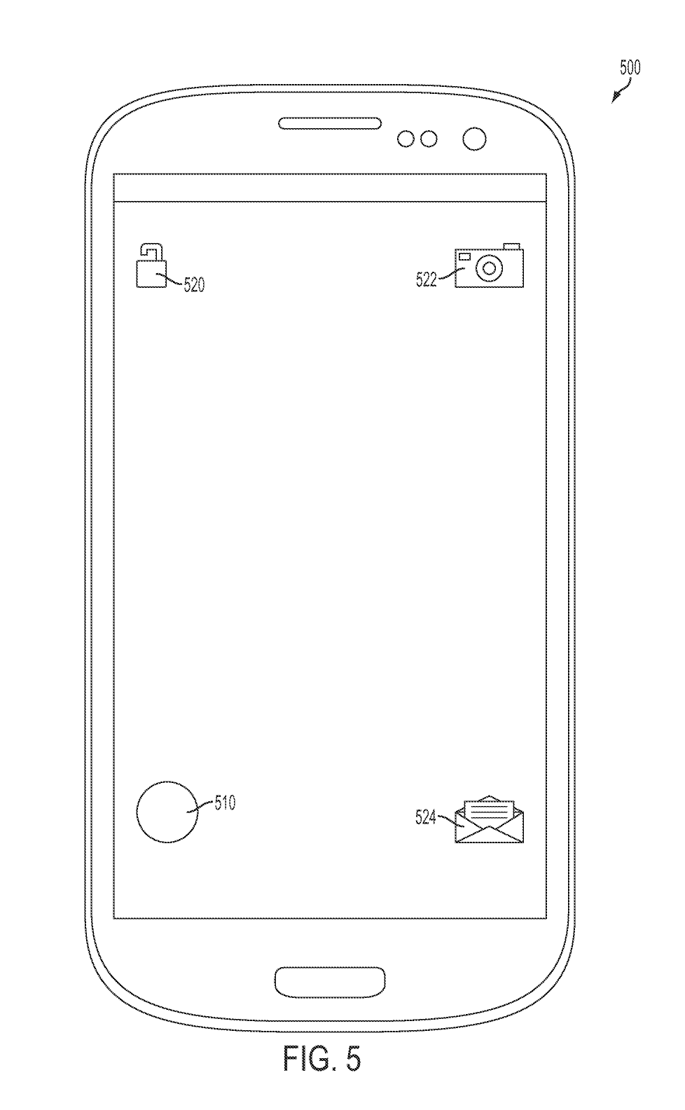

FIG. 5 shows an initial screen display according to an exemplary embodiment of the present invention.

In the exemplary embodiment of FIG. 5, a particular application may be launched according to the user's unlocking input of a device 500.

Referring to FIG. 5, each of the multiple immoveable objects 520-524 is depicted as an icon. Each icon represents at least one function of the device 500. For example, a first icon 520 may be depicted as a lock, and may represent generally unlocking the device 500. A second icon 522 may be depicted as a camera, and may represent launching a camera application. A third icon 524 may be depicted as a telephone handset, and may represent launching a telephone function.

The icons may be predetermined according to the installed applications. Alternatively, a user may select any icon or image to correspond to any application. As in the above described exemplary embodiments, it is preferred that the user can readily discern a corresponding application or function from the appearance of each icon.

When a user unlocks the device 500, he may move the moveable object 510 to a selected one of the immoveable objects 520-524. When the user moves the moveable object 510 to one of the moveable objects 520-524, the device 500 is unlocked and immediately launches a corresponding application. For example, if a user wishes to take a picture, he may unlock the device 500 by moving the moveable object 510 to the immoveable object camera icon 522. When he does so, the device 500 unlocks and immediately launches the camera application. Thus, the user may efficiently unlock the device and use an application that is automatically launched immediately.

In the exemplary embodiment of FIG. 5, a location and function of each of the various immoveable objects may be predetermined according to the manufacture. Alternatively, a location and function of each of the immoveable objects may be predetermined or according to a user selection.

Alternatively, a location and function of each of the various immoveable objects may be dynamically determined. For example, the immoveable objects may represent one or more most recently used applications. For another example, the immoveable objects may represent one or more most frequently used applications.

For yet another example, the immoveable objects may represent one or more objects with pending notification (e.g., a missed incoming call, unread messages, etc.). The icon may represent not only the type of pending notification, but may also represent additional information. If the notification represents a phone call, for example, the phone number of the caller may be displayed in the corresponding immoveable object. If a user has associated a picture with a particular email address or phone number in an address book, for example, the icon might combine that picture with an icon representing a received email, received text message, or missed phone call from that entry in the address book. The indication may include a most recent pending notification, or may include multiple notifications of a type, for example, pictures of multiple people from an address book from whom text messages are pending. Thus, the user may determine quickly, for example, whether responding to pending text messages is a higher priority than checking pending missed calls, according to the senders or callers indicated.

Any combination of the above is of course also possible. For example, one immoveable object might correspond to a most recently used application, another immoveable object might correspond to a most frequently used application different from the most recently used application, and a third immoveable object might correspond to an application with pending notification different from the most recently used and most frequently used applications.

These exemplary embodiments may of course be combined. For example, a user may be required to enter a sequence of moves as a password to unlock the device. Upon entering the correct password sequence, the embodiment of FIG. 5 may be used such that the user can immediately launch a desired application.

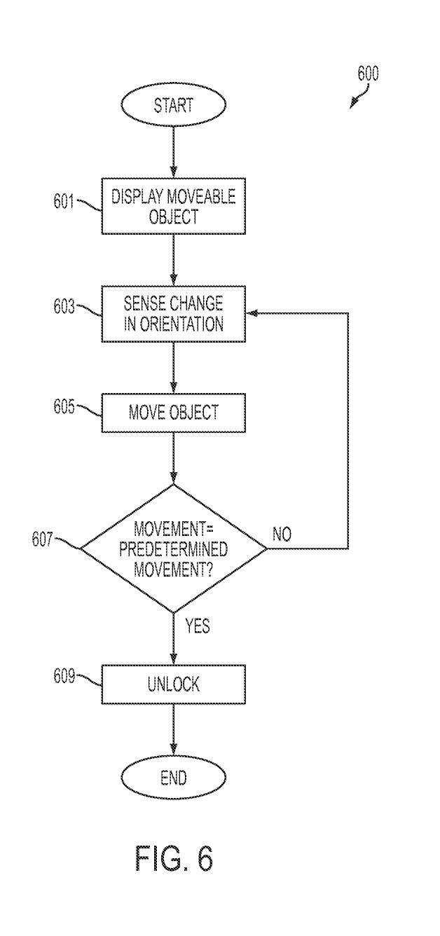

FIG. 6 is a flowchart of an unlocking process according to an exemplary embodiment of the present invention.

Referring now to FIG. 6, the process starts when the device receives an input triggering the start of an unlocking operation. For example, the triggering input may be a momentary press of a power button.

At step 601 at least one moveable object is displayed on a display screen. The display of the moveable object and the movement thereof visually informs a user of what input the device senses. As discussed above, an initial position of the moveable object will be determined in accordance with a direction in which the object would move if subject to gravity.

At step 603 at least one orientation sensor senses a change in orientation of the device. At step 605 the moveable object is moved on the display in accordance with the sensed change in orientation.

At step 607 it is determined whether the movement of the moveable object is in accordance with the predetermined movement. For example, the predetermined movement may be any movement that results in the moveable object being located at the position of a displayed immoveable object. Alternatively, the predetermined movement may be a sequence of movements of the moveable object to a particular sequence of locations on the display, where the locations are indicated by one or more immoveable objects. If the movement is not the predetermined movement, then the device returns to step 603 to sense a change in orientation as the basis for another movement of the moveable object.

If it is determined in step 607 that the movement is the predetermined movement, the device will unlock in step 609. The unlocking may unlock the device generally. Alternatively, the unlocking may present the user with immoveable objects representing one or more optional applications that can be launched immediately according to a sensed movement.

Although not depicted in FIG. 6, a device according to an exemplary embodiment of the present invention might have a limited time in which it will receive the unlocking signal. Thus, if the predetermined movement is not determined within the limited time, the device will return to a sleep mode. Methods to implement such a limited time for unlocking are known in the related art, and thus will not be explained in detail herein.

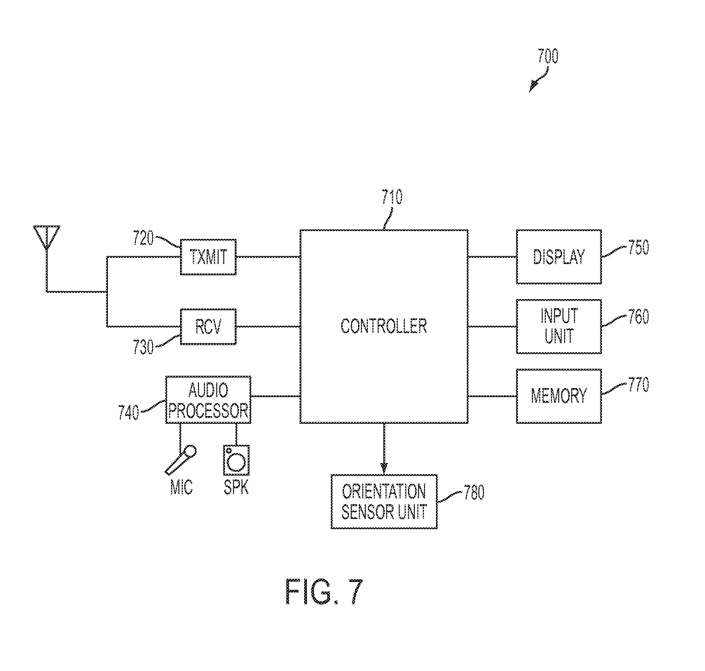

FIG. 7 is a block diagram of a portable device according to an exemplary embodiment of the present invention.

Referring now to FIG. 7, a device 700 according to an exemplary embodiment of the present invention will include a controller 710, a display 750, an input unit 760, a memory 770, and orientation sensor unit 780.

The device 700 might optionally also include a transmitter 720 and a receiver 730 for wireless communication.

The device 700 might optionally also include an audio processor 740. If the audio processor 740 is included, then at least one of a microphone MIC and a speaker SPK may also be included.

The controller 710 controls overall operations of the device. The controller 710 may control any operations that are implicitly or explicitly performed by a device, including an operating system, applications, and control of various hardware, for example, a camera, a wireless transceiver, etc.

The display 750 provides a visual output. The input unit 760 may include one or more of buttons and a touchscreen. If the touchscreen is included, the input unit 760 and the display 750 may be combined as a single unit.

The memory 770 stores software such as an operating system or applications, and data required for or produced during use of the device 700.

The orientation sensor unit 780 includes one or more orientation sensors. The orientation sensors are capable of detecting a three dimensional orientation of the device 700. Information of the orientation is sent to the controller 710. The controller 710 is capable of determining a direction and extent of a change in orientation by comparing signals from the orientation sensor unit 780 received at different times. Alternatively, the orientation sensor unit 780 may be configured detect the change in orientation, and to send information of the initial orientation or of the change in orientation to the controller 710.

The controller 710 will control all normal operations of the device 700 and of any executed applications. The controller 710 will determine an initial position of the moveable object on the display 750, and will control the moveable object to move according to information received from the orientation sensor unit 780. The controller 710 will determine whether the moveable object has moved in accordance with a predetermined movement. If the controller 710 determines that the moveable object has moved in accordance with the predetermined movement, then it will unlock the device 700. Information of the predetermined movement may be stored in the memory 700.

According to an exemplary embodiment of the present invention, a device will dynamically determine characteristics of an unlock action. For example, the device will dynamically determine a number of moveable objects and their initial positions and a number of immoveable objects and their initial positions. Factors that influence the determination of the positions include but are not limited to an initial three dimensional orientation of the device when a user starts the unlocking, and inputs from a randomizer or intelligence engine when there is a tie for initial positions. Additional factors that can influence the numbers of the moveable and immoveable objects include but are not limited to a user preference on unlock reliability, a user preference on ease of unlock, and a user preference or heuristic determination of possible applications to be launched post unlock.

In all cases the user can enter the inputs by holding the device in a single hand and tilting the device. No touch selection of keys, which are often smaller than a user's fingertips, is necessary. Similarly, no input is out of reach of the fingers or thumb of the hand holding the device. Thus, the user can always easily and accurately unlock the device by tilting the device with one hand.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for unlocking in a portable electronic device via orientation sensing, the device comprising a display screen and at least one orientation sensor, the method comprising:
displaying at least one moveable object on the display screen;
sensing a change in an orientation of the device;
moving the moveable object in accordance with the sensed change in orientation; and
unlocking the device if the moveable object moves in accordance with a predetermined movement.

2. The method of claim 1, further comprising:
sensing an initial orientation of the device; and
determining an initial position of the moveable object according to the initial orientation.

3. The method of claim 2, further comprising:
displaying at least one immoveable object on the display screen,
wherein the predetermined movement comprises moving the moveable object according to the sensed change in orientation.

4. The method of claim 3, wherein the predetermined movement comprises moving the moveable object to a location of the immoveable object.

5. The method of claim 4, further comprising determining an initial position of the immovable object according to the initial orientation.

6. The method of claim 5, wherein the initial position of the moveable object is determined according to a position to which the moveable object would move if the moveable object was subject to gravity or had a negative weight, and
wherein the initial position of the immoveable object is according to a position from which the moveable object would move away if the moveable object was subject to gravity or had the negative weight.

7. The method of claim 4, wherein the at least one immoveable object comprises a plurality of immoveable objects, and
wherein the predetermined movement comprises moving the moveable object to one of the plurality of immovable objects.

8. The method of claim 7, wherein the unlocking of the device comprises launching an application.

9. The method of claim 8, wherein the launched application is determined according to an associated one of the plurality of immoveable objects.

10. The method of claim 9, wherein each of the plurality of immoveable objects comprises a different visual appearance corresponding to an associated application to be launched.

11. The method of claim 9, wherein at least one application associated with an immoveable object is predetermined according to a user's selection.

12. The method of claim 9, wherein at least one application associated with an immoveable object is predetermined heuristically.

13. The method of claim 12, wherein the at least one application comprises a most recently used application.

14. The method of claim 12, wherein the at least one application comprises a most used application.

15. The method of claim 12, wherein the at least one application comprises an application with pending notification.

16. The method of claim 7, wherein the predetermined movement comprises moving the moveable object to a predetermined sequence of the immoveable objects.

17. The method of claim 16, wherein the predetermined sequence comprises a password.

18. The method of claim 16, wherein when the moveable object has moved to the predetermined sequence of the immoveable objects, at least one immoveable object is displayed with a visual appearance indicating a corresponding application that is launched if the moveable object is moved to the at least one immoveable object with the visual appearance indicating the application.

19. The method of claim 1, further comprising:
sensing an initial orientation of the device; and
determining an initial position of the moveable object,
wherein the moving of the moveable object according to sensed change in orientation comprises moving the moveable object if the sensed change in orientation is at least a predetermined threshold different from the sensed initial orientation.

20. A portable electronic device comprising:
a display screen for displaying at least one moveable object;
at least one orientation sensor for sensing a change in an orientation of the device; and
a controller for controlling the displayed moveable object to move according to the change in the orientation of the device, for determining whether the moveable object moves in accordance with a predetermined movement, and for unlocking the device if the moveable object moves in accordance with the predetermined movement.

21. The device of claim 20,
wherein the display screen further displays at least one immoveable object,
wherein the controller controls the moveable object to move according to a direction in which the moveable object would move if the moveable object was subject to gravity or had a negative weight, and
wherein the predetermined movement comprises moving the moveable object to the immoveable object.

22. The device of claim 21, wherein the at least one immoveable object comprises a plurality of immoveable objects.

23. The device of claim 22, wherein the unlocking of the device comprises launching an associated application if the moveable object moves to a predetermined one of the plurality of immoveable objects.

24. The device of claim 23, wherein a visual appearance of the predetermined one of the plurality of immoveable objects is determined according to the associated application.

25. The device of claim 24, wherein the application associated with the at least one immoveable object is determined according to a user's selection.

26. The device of claim 24, wherein the application associated with the at least one immoveable object is determined heuristically.

27. The device of claim 26, wherein the application comprises a most recently used application.

28. The device of claim 26, wherein the application comprises a most frequently used application.

29. The device of claim 26, wherein the application comprises an application with pending notification.

30. The device of claim 22, wherein the predetermined movement comprises moving the moveable object to a predetermined sequence of the plurality of immoveable objects.

31. The device of claim 30, wherein the predetermined sequence comprises a password.

32. The device of claim 20,
wherein the orientation sensor further senses an initial orientation of the device, and
wherein the controller determines that the moveable object moves according to the sensed change in orientation that is at least a predetermined threshold different from the sensed initial orientation.
